(19) United States
(12) Patent Application Publication
(10) Pub. No.: US 2026/0073896 A1
(43) Pub. Date: Mar. 12, 2026

(54) REMOVABLE ELECTRONIC DRUM HEAD AND/OR DEADENING PAD

(71) Applicant: Ramy Antoun, Spicewood, TX (US)

(72) Inventor: Ramy Antoun, Spicewood, TX (US)

(21) Appl. No.: 18/883,614

(22) Filed: Sep. 12, 2024

(51) Int. Cl. G10D 13/20; G10D 13/10; G10D 13/18

(52) U.S. Cl. CPC G10D 13/20; G10D 13/18; G10D 13/25

(57) ABSTRACT

Particular embodiments described herein provide for a drum that includes a drum head, a removable electronic drum head under the drum head, a deadening pad under the removable electronic drum head, and a drum head release mechanism. The drum head release mechanism can be activated to help remove the drum head, the removable electronic drum head, and the deadening pad from the drum and then can be reactivated to secure the drum head to the drum without the removable electronic drum head, and the deadening pad.

### TECHNICAL FIELD

This disclosure relates in general to the field of music instruments, and more particularly, to a removable electronic drum head and/or deadening pad.

### BACKGROUND

The drum is a member of the percussion group of musical instruments. In the Hornbostel-Sachs classification system, it is considered a membranophone. Generally, drums typically consist of at least one membrane often called a drum head or drum skin, that is stretched over a shell. The drum head is struck either directly with the player's hands or with a device, such as a drum stick, to produce sound. Drums are the world's oldest musical instruments and the basic design has remained virtually unchanged for thousands of years.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified perspective diagram of a removable electronic drum head and deadening pad, in accordance with an embodiment of the present disclosure;

FIG. 2 is a simplified block diagram of a removable electronic drum head and deadening pad, in accordance with an embodiment of the present disclosure;

FIG. 3 is a simplified exploded block diagram illustrating example details of a removable electronic drum head and deadening pad, in accordance with an embodiment of the present disclosure;

FIG. 4 is a simplified block diagram illustrating example details of a removable electronic drum head, in accordance with an embodiment of the present disclosure;

FIG. 5 is a simplified block diagram illustrating example details of a removable electronic drum head, in accordance with an embodiment of the present disclosure;

FIGS. 6A-6E are simplified block diagrams illustrating example details of a removable electronic drum head, in accordance with an embodiment of the present disclosure;

FIGS. 7A-7C are simplified block diagrams illustrating example details of a portion of a removable electronic drum head and deadening pad, in accordance with an embodiment of the present disclosure;

FIGS. 8A-8C are simplified block diagram illustrating example details of a portion of a deadening pad, in accordance with an embodiment of the present disclosure;

FIG. 9 is a simplified flowchart illustrating potential operations that may be associated with the system in accordance with an embodiment;

FIG. 10 is a simplified flowchart illustrating potential operations that may be associated with the system in accordance with an embodiment;

FIG. 11 is a simplified flowchart illustrating potential operations that may be associated with the system in accordance with an embodiment;

FIG. 12 is a simplified flowchart illustrating potential operations that may be associated with the system in accordance with an embodiment;

FIG. 13 is a simplified flowchart illustrating potential operations that may be associated with the system in accordance with an embodiment;

FIG. 14 is a simplified flowchart illustrating potential operations that may be associated with the system in accordance with an embodiment; and FIG. 15 is a simplified flowchart illustrating potential operations that may be associated with the system in accordance with an embodiment.

The FIGURES of the drawings are not necessarily drawn to scale, as their dimensions can be varied considerably without departing from the scope of the present disclosure.

### DETAILED DESCRIPTION

### Example Embodiments

The following detailed description sets forth examples of apparatuses, methods, and systems relating to a system for enabling a removable electronic drum head and/or deadening pad in accordance with an embodiment of the present disclosure. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

The terms “over,” “under,” “below,” “between,” and “on” as used herein refer to a relative position of one layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “directly on” a second layer is in direct contact with that second layer. Similarly, unless explicitly stated otherwise, one feature disposed between two features may be in direct contact with the adjacent features or may have one or more intervening layers.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” includes a plus or minus twenty percent (±20%) variation. For example, about one (1) millimeter (mm) would include one (1) mm and ±0.2 mm from one (1) mm. Similarly, terms indicating orientation of various elements, for example, “coplanar,” “perpendicular,” “orthogonal,” “parallel,” or any other angle between the elements generally refer to being within plus or minus five to twenty percent (+/−5-20%) of a target value based on the context of a particular value as described herein or as known in the art.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments.

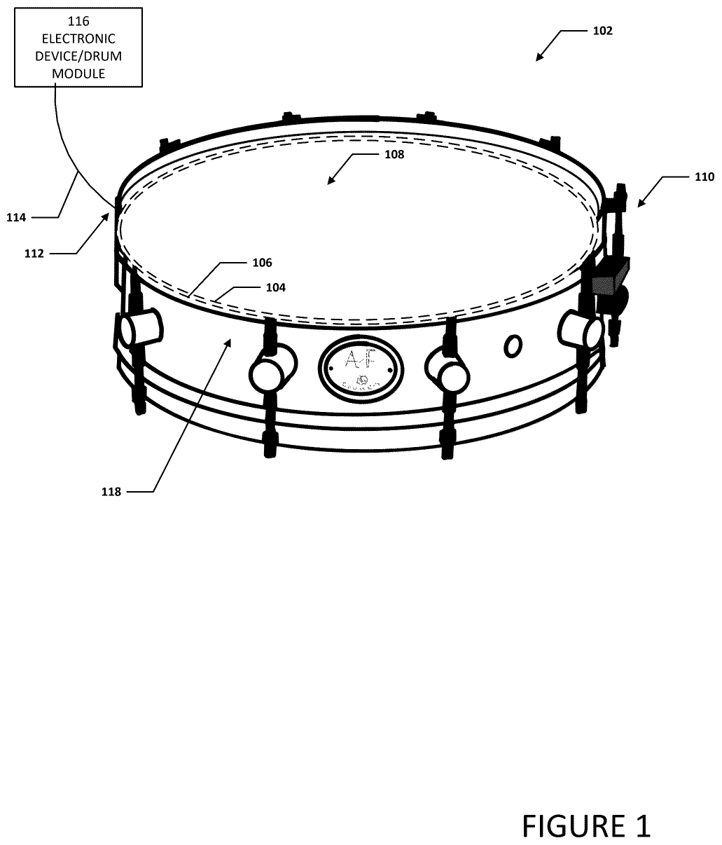

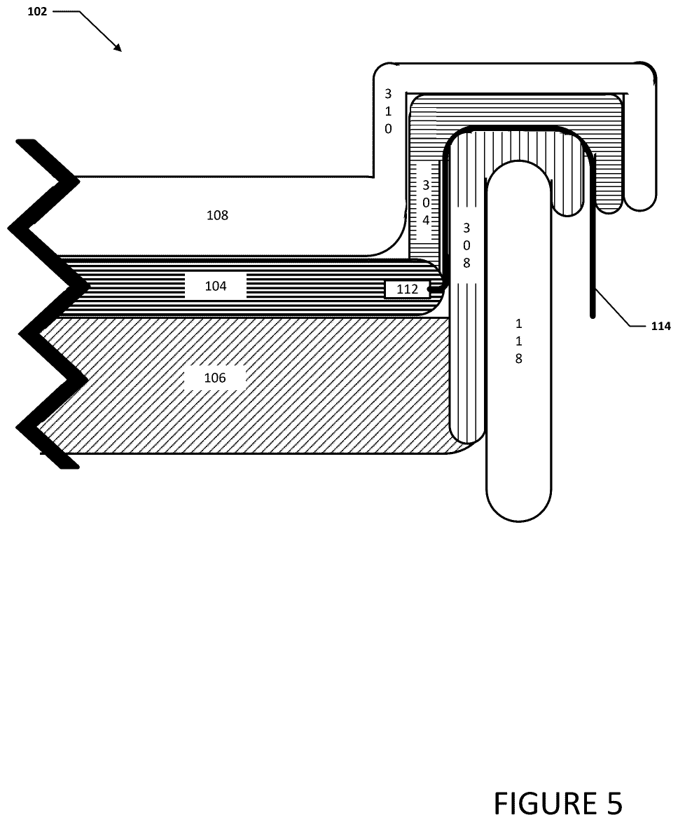

FIG. 1 is simplified block diagram of a drum 102 that includes a removable electronic drum head 104 and deadening pad 106, in accordance with an embodiment of the present disclosure. In an example, the drum 102 is an acoustic drum and can include the removable electronic drum head 104, the deadening pad 106, a drum head 108, a drum head release mechanism 110, and a shell 118. The shell 118 is the body of the drum 102 and supports the deadening pad 106, the removable electronic drum head 104, and the drum head 108 (e.g., as illustrated in FIG. 5). In some examples, depending on the type of drum 102, the deadening pad 106, the removable electronic drum head 104, and the drum head 108 are attached or secured to the shell 118 with bolts, called tension rods, that are screwed into lugs on the shell 118. In other examples, other means are used to attached the deadening pad 106, the removable electronic drum head 104, and the drum head 108 are attached or secured to the shell 118 of the drum 102.

The removable electronic drum head 104 can include a trigger sensor 112. A data cable 114 can extend from the trigger sensor 112 on the removable electronic drum head 104, over the shell 118, and to an electronic device 116. The electronic device can be a drum module that produces a sound in response to a signal from the trigger sensor 112 that the removable electronic drum head 104 detected a hit or strike on the drum head 108.

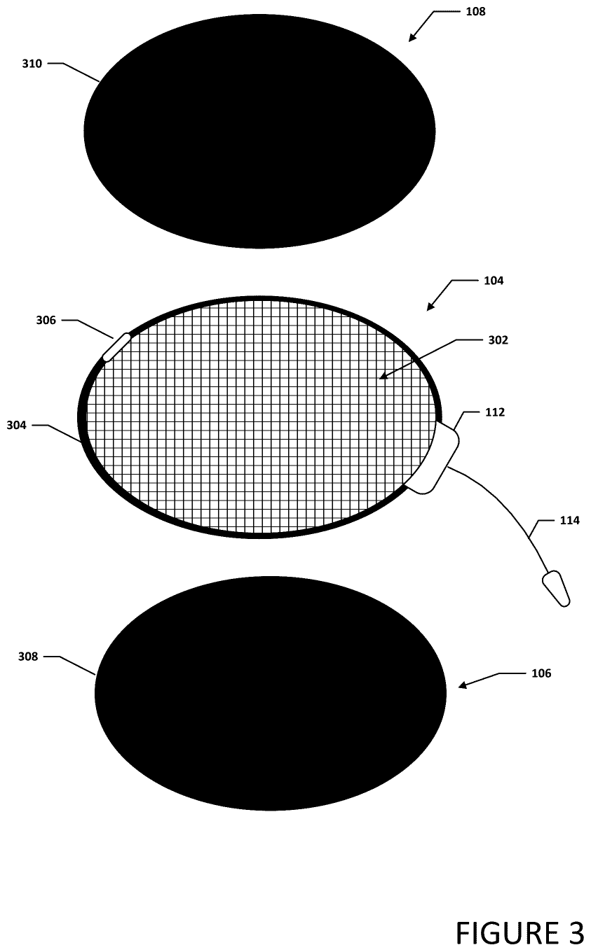

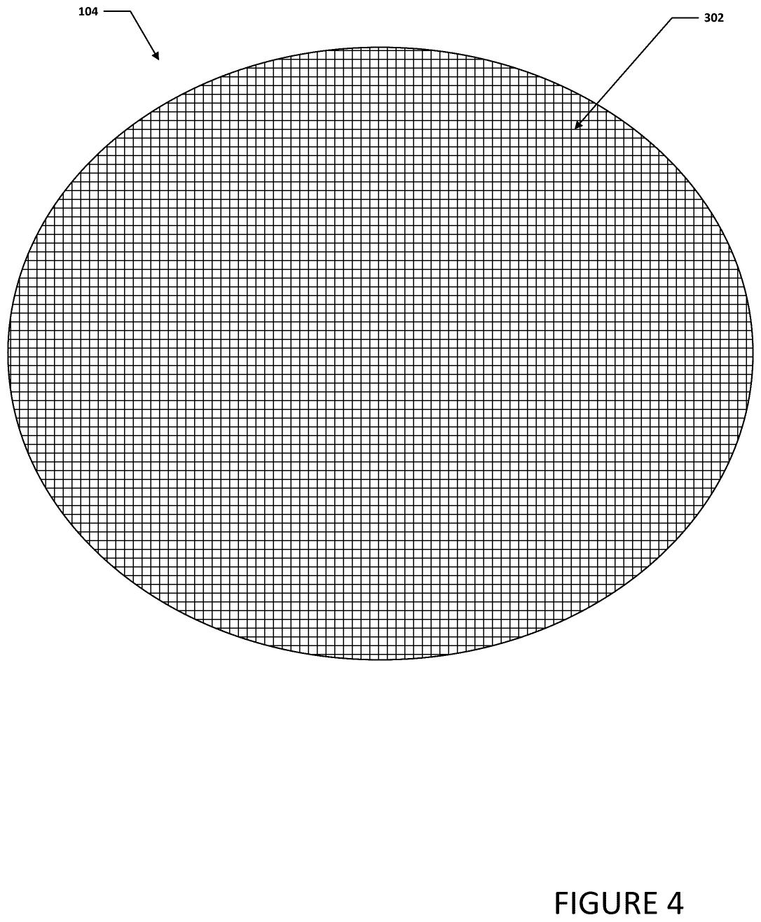

The removable electronic drum head 104 can include triggers (illustrated in FIGS. 3 and 4) and one or more triggers sensors 112. The triggers can cover at least a majority of the removable electronic drum head 104 and may be in a mesh or grid like pattern. The removable electronic drum head 104 can be comprised of conductive material (the triggers) and non-conductive material. In some examples, the triggers are similar to conductive traces embedded in non-conductive material. The deadening pad 106 can be comprised of leather, foam, felt rubber or some other material or a composite of material that can help deaden the sound when the drum head 108 of the drum 102 is struck. The deadening pad 106 can be single ply or multi-ply.

The removable electronic drum head 104 and the deadening pad 106 can be relatively thin. For example, the removable electronic drum head 104 can have a thickness less than about one (1) inch. In some examples, the removable electronic drum head 104 can have a thickness in the range of about 0.1 inches to about 0.75 inches and ranges therein (e.g., about 0.2 inches to about 0.5 inches, about 0.1 inches to about 0.2 inches, etc.). The thickness of the deadening pad 106 depends on the material and amount of desired dampening. In some examples, the thickness of the deadening pad 106 is less than about three (3) inches.

The removable electronic drum head 104 and the deadening pad 106 can be purchased as a set together or each of the removable electronic drum head 104 and the deadening pad 106 can be purchased separately. The removable electronic drum head 104 and the deadening pad 106 can be added to any acoustic drum 102 (any drum head 108), even old drums more than twenty (20) years old, to help convert the drum 102 into an electronic drum. When the user wants to convert back to an acoustic drum, the removable electronic drum head 104 and the deadening pad 106 can be removed without damaging the drum 102 or the drum head 108. Because the removable electronic drum head 104 and the deadening pad 106 are located below the drum head 108, the removable electronic drum head 104 and the deadening pad 106 do not greatly change the aesthetics of the drum as compared to rim mounted triggers.

The removable electronic drum head 104 has approximately the same shape and surface area as the drum head 108 and the removable electronic drum head 104 includes a mesh of drum triggers (e.g., see FIGS. 3 and 4) and one or more trigger sensors 112. When the removable electronic drum heat 104 is inserted or positioned below the drum head 108, the drum 102 can be played without the data cable 114 plugged into the trigger sensors 112. The data cable 114 can be a ribbon data cable or flat data cable. In some examples, the data cable 114 has a thickens that is between about 0.2 mm to about 2.5 mm and ranges therein (e.g., between about 0.5 mm to about 1.5 mm, between about 0.75 to about 1.25 mm, etc.). In other examples, the data cable 114 has a thickness less than about seven (7) mm. In yet other examples, the data cable 114 has a thickness less than about three (3) mm. The color of the data cable 114 can be a color that matches or compliments the aesthetics of the drum 102 and/or a user's color preference. For example, if the drum 102 has red tones or red coloring, the data cable 114 can be red or include red tones, if the drum 102 has blue tones or blue coloring, the data cable 114 can be blue or include blue tones, or any other color or combination of colors to match or compliment the aesthetics of the drum 102 and/or a user's color preference.

Unlike some drum triggers, the removable electronic drum head 104, the deadening pad 106, and the data cable 114 can be used on vintage drums, drums with wood hoops, drums with single flanged hoods, or any other drum, as opposed to some drum triggers that can only be used on drums that have a triple fanged hoop. Because the removable electronic drum head 104 and the deadening pad 106 are located under the drum head 108 and the data cable 114 can be a ribbon or flat cable, the removable electronic drum head 104, the deadening pad 106, and data cable 114 (which can be almost any color) do not greatly affect the aesthetics of the drum as compared to most drum triggers that extend above the rim or hoop of the drum and/or use relatively large cables (e.g., greater than 3 mm) that are not aesthetically pleasing and can interfere or get in the way of playing the drum. Also, because the drum triggers cover most if not all of the drum head 108, the response to a strike on the drum head is even across the entire drum head and does not have not have limited response areas or an uneven reaction across the whole surface of the drum, in contrast to internal side mounted drum triggers or center mounted drum triggers that have limited response areas or an uneven reaction across the whole surface of the drum. In addition, the removable electronic drum head 104 and the deadening pad 106 can be relatively easily removed as compared to internal side mounted drum triggers or center mounted drum triggers where repeated removal and reattachment of the internal side mounted drum triggers or center mounted drum triggers can damage the drum and/or the drum head and often will leave a sticky adhesive residue on the drum.

In some examples, the removable electronic drum head 104 and the deadening pad 106 can be used on a cymbal. For example, the removable electronic drum head 104 and the deadening pad 106 can be sculpted or have a profile that matches the profile of the cymbal. The sculpted removable electronic drum head 104 and the deadening pad 106 can be secured under the cymbal to help convert the cymbal into an electronic cymbal.

It is to be understood that other embodiments may be utilized and structural changes may be made without departing from the scope of the present disclosure. Substantial flexibility is provided by the drum 102, the removable electronic drum head 104, and/or the deadening pad 106 in that any suitable arrangements and configuration may be provided without departing from the teachings of the present disclosure. Elements of the figures may be coupled to one another through one or more attachment means employing any suitable coupling and/or connections. Additionally, any one or more of these elements of the figures may be combined or removed from the architecture based on particular configuration needs.

For purposes of illustrating certain example techniques of the drum 102, the removable electronic drum head 104, and/or the deadening pad 106, the following foundational information may be viewed as a basis from which the present disclosure may be properly explained. There are many reasons why a user may want to convert an acoustic drum to an electronic drum and one of those reasons is volume level. To convert an acoustic drum to an electronic drum, drum triggers can be used. Drum triggering makes a lot of sense, especially for club work. Every room sounds different, the quality of the PA is all over the map, and the quality and quantity of the microphones are often unsatisfactory.

Currently, clip-on drum triggers are the most common type of triggers that can be attach to the rim of an acoustic drum to convert the acoustic drum to an electronic drum. Most triggers are dual triggers, meaning the triggers can pick up both the rim shots and strikes on the drum head. Clip-on drum triggers are the generally the least expensive drum triggers, but also the most fragile. Since, clip-on drum triggers mount to the head with adhesive or double-stick tape, they usually stay on the drum all the time. This can be a problem when a user wants to switch back and forth between using an acoustic drum and an electronic drum. Also, most clip-on drum triggers do not have any sensor height adjustment to compensate for varying rim heights. Depending on the drum rim the clip-on drum trigger mounts to, the clip-on drum triggers may not even reach the head of the drum if the rim or the drum is very high, or in the case of low rims, may muffle the drum by pressing down on the head with enough force to muffle the drum. In addition, clip-on drum triggers are an add-on feature to the drum, extend from the rim of the drum, are not aesthetically pleasing, and can ruin a look or aesthetics of a drum. Because the drum triggers extend above the hoop or rim of the drum, the drum triggers must be positioned such that the drum triggers do not get in the way when the drum is played. Also, the drum triggers cannot attach to any other hoops other than triple flanged hoops. More specifically, clip-on drum triggers cannot be used on vintage drums, wood hoops, single flanged hoods, or any other drum that does not have a triple fanged hoop. Most drum triggers use relatively large cables that are also not aesthetically pleasing and the cables can interfere with a user playing the drum.

Internal side-mounted drum triggers allow a user to hide the triggers inside the shell of the drum by mounting the triggers onto one of the screws that are inside of the drum. In order to do mount the internal side mounted triggers inside the drum, the user needs to take out the drum head, install the internal side mounted triggers inside the drum, and then put the drum head back onto the drum. However, internal side mounted triggers can be difficult to position correctly and have limited response areas or an uneven reaction across the whole surface of the drum head. More specifically, if the head of the drum is struck far away from the internal side mounted drum trigger, the internal side mounted drum trigger will have less of a reaction to the strike as compared to when the head is struck near the internal side mounted drum trigger and there is an uneven response based on where the drum head is stuck. Also, the internal side mounted drum triggers are not easily removed and repeated removal and reattachment of the internal side mounted drum trigger can damage the drum and/or drum head. Most of the internal side mounted drum triggers are attached with adhesive and when the internal side mounted drum trigger is removed, the adhesive leaves a residue on the drum.

Some drum triggers are center mounted. The difference between center-mounted and side-mounted triggers is that center-mounted triggers can also pick up positional sensing. There are internal center-mounted drum triggers that have arms that spread to every single lug inside the drum shell, distributing the force of the drum being hit, evenly. Center mounted drum triggers can be difficult to install and center mounted drum triggers are easily broken. Also, center mounted drum triggers have a microphone and the microphone picks up sound on the head as well as the sounds that bounces back from the bottom of the drum. In addition, similar to the internal side mounted drum triggers, the center mounted drum triggers have limited response areas or an uneven reaction across the whole surface of the drum head. Center mounted drum triggers not easily removed and repeated removal and reattachment of the center mounted drum trigger can damage the drum and/or the drum head.

The drum triggers detect a hit or strike on the drum and send a signal to a drum module using a cable. Where the cable is located can become an issue, especially for internally mounted drum triggers. Typically, the cable for some current drum triggers extends through the air vents of the shell of the drum. Some companies, in order to help the user accommodate the drum cable, go as far as creating a male-to-female input jack that the user can mount in an air vent of the drum and the user plugs the cables into the male-to-female input jack. There is also an issue where some acoustic drum shells don't have large enough air vents to accommodate the inputs of the cable. In that case, the user may drill the air vents until they are large enough to accommodate the cable. However, drilling the air vents is not recommend as it can greatly affect the sound of the drum. Another option is that the user can disassemble the male-to-female input jack, run the cable through the vent, and then assemble the male-to-female input jack once the cable is positioned inside the drum. However, disassembling and reassembling the male-to-female input jack can be difficult for some users.

Drum trigger modules are electronic devices that are used to trigger sound samples and MIDI notes in response to a detected hit or strike on the drum. To use a drum trigger module, a user connects the trigger to the module using the cable, and then connects the audio output of the module to an amp, PA system or mixing desk. Some modules also have the ability to adjust the sensitivity and threshold of the trigger so the user can fine-tune the response to the user's playing style. Using a drum trigger with a drum module allows a user to add a wide range of sounds to their drum setup, such as different drum kits, sound effects, or loops.

When using drum triggers, dampening pads are often used on the top of the drum. When the drum is struck or hit, the dampening pads can cause one or more of less ringing of the drum, less overtones, less sustain, less high-pitch frequencies, less tone, and/or less volume Typical dampening pads look like thick foam pads, and they come in different shapes and sizes depending on what type of drums or cymbals they're meant to cover. Dampening pads on the top of the drum can affect the aesthetics of the drum.

A system, method, apparatus, means, etc. to help enable a removable electronic drum head and/or deadening pad can help resolve the above described issues (and others). In an example, a removable electronic drum head can be added to an acoustic drum to create an electronic drum. In some examples, in addition to the removable electronic drum head, a deadening pad can also be added to the drum. In other examples, the deadening pad can be added to the drum without the removable electronic drum head. The removable electronic drum head and/or the deadening pad can be added and removed by the user whenever the user wants to switch from an acoustic drum to an electronic drum, and then back to the acoustic drum. The removable electronic drum head extends across or covers almost the entire surface (bottom surface or the surface of the drum head that is opposite of the surface that is struck) of the drum head, or at least a majority of the drum head, and detects a strike where the strike occurs for an even response, as opposed to internal sound mounted triggers where if the drum head is struck far away from the trigger (e.g., on an opposite side of the drum head from where the trigger is located), the response may be less of a response as compared to the response when the drum head is struck near the trigger.

The removable electronic drum head and the deadening pad can be purchased as a set together or each of the removable electronic drum head and the deadening pad can be purchased separately. Unlike the side mounted triggers, the removable electronic drum head and the deadening pad can be added to any acoustic drum to help convert the acoustic drum into an electronic drum. Also, unlike the side mounted triggers, because the removable electronic drum head and the deadening pad are located below the drum head, the removable electronic drum head and the deadening pad do not greatly change the aesthetics of the drum and do not extend above the hoop or rim of the drum and do not interfere when the drum is played.

In addition, because the drum triggers in the removable electronic drum head cover most if not all of the drum head, the response to a strike on the drum head is even across the entire drum head and the electronic drum head does not have not have limited response areas or an uneven reaction across the whole surface of the drum as compared to internal side mounted drum triggers or center mounted drum triggers that do have limited response areas or an uneven reaction across the whole surface of the drum. Also, when the user wants to convert back to an acoustic drum, the removable electronic drum head and the deadening pad can be removed without damaging the drum or the drum head and the removable electronic drum head and the deadening pad can be relatively easily removed as compared to internal side mounted drum triggers or center mounted drum triggers where repeated removal and reattachment of the internal side mounted drum triggers or center mounted drum triggers can damage the drum and/or the drum head and often will leave a sticky adhesive residue on the drum.

The removable electronic drum head includes one or more trigger sensors. A data cable can connect the trigger sensors to a drum module. The data cable can be a ribbon or flat cable. In some examples, the data cable has a thickens that is between about 0.1 mm to about three (3) mm and ranges therein (e.g., between about 0.5 mm to about two (2) mm, between about 0.75 to about 1.5 mm, etc.). In other examples, the data cable has a thickness less than about four (4) mm, less than about five (5) mm, or less than about six (6) mm. The color of the data cable can be a color that matches or compliments the aesthetics of the drum and/or a user's color preference. For example, if the drum has green tones or green coloring, the data cable can be green, include green tones, or any other color or combination of colors to match or compliment the aesthetics of the drum 102 and/or a user's color preference.

Because the removable electronic drum head 104 and the deadening pad 106 are located under the drum head 108 and the data cable 114 can be a ribbon or flat cable, the removable electronic drum head 104, the deadening pad 106, and data cable 114 (which can be almost any color) do not greatly affect the aesthetics of the drum as compared to most drum triggers that extend above the rim or hoop of the drum and/or use big cables that are not aesthetically pleasing and can get in the way of playing the drum.

In some examples, the removable electronic drum head and the deadening pad can be used on a cymbal. For example, the removable electronic drum head and the deadening pad can be sculpted or have a profile that matches the profile of the cymbal. The sculpted removable electronic drum head and the deadening pad can be secured under the cymbal to help convert the cymbal into an electronic cymbal.

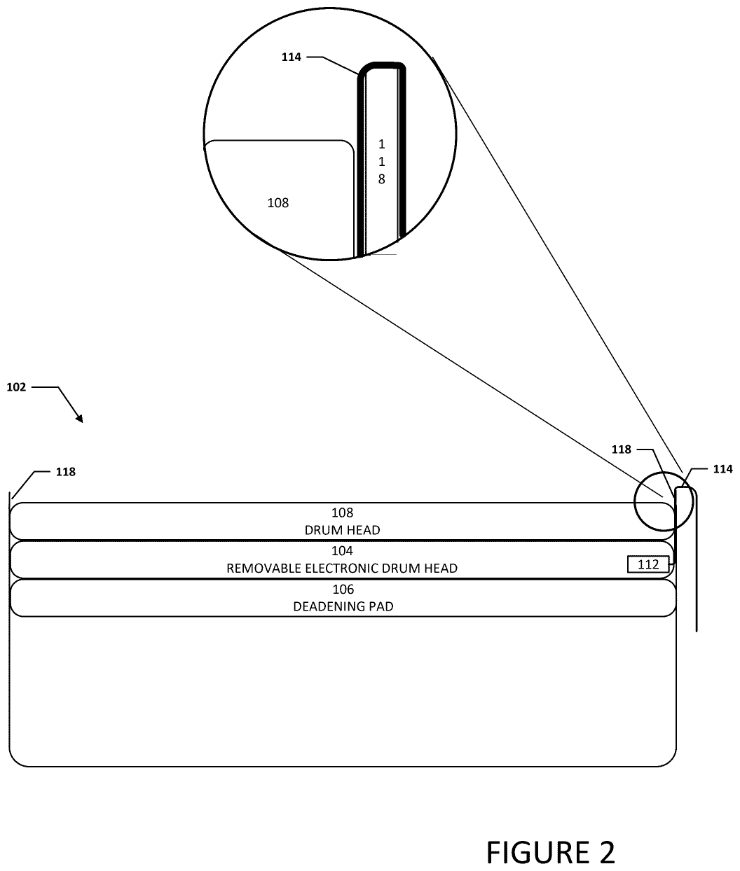

Turning to FIG. 2, FIG. 2 illustrates a cutaway side view of the drum 102. The drum 102 can include the drum head 108, the removable electronic drum head 104, and the deadening pad 106. The removable electronic drum head 104 can include the trigger sensor 112. The data cable 114 can extend from the trigger sensor 112 on the removable electronic drum head 104, over the shell 202 of the drum 102, and to the electronic device 116 (not shown). Note that the means to attached drum head 108, the removable electronic drum head 104, and the deadening pad 106 to the shell 118 of the drum 102 is not shown in FIG. 2.

Turning to FIG. 3, FIG. 3 illustrates an exploded view of a portion of the drum 102 (not shown). The drum 102 can include the drum head 108, the removable electronic drum head 104, and the deadening pad 106. The removable electronic drum head 104 can include the trigger sensor 112, triggers 302, a removable electronic drum head flesh hoop 304 and a size adjustment mechanism 306. The removable electronic drum head flesh hoop 304 helps to secure/support the removable electronic drum head 104 to/on the shell of the drum 102. In some examples, other means are used to secure/support the removable electronic drum head 104 to/on the shell of the drum 102. The deadening pad 106 can include a deadening pad flesh hoop 308. The deadening pad flesh hoop 308 helps to secure/support the deadening pad 106 to/on the shell of the drum 102. In some examples, other means are used to secure/support the deadening pad to/on the shell of the drum 102. In some examples, the removable electronic drum head 104 does not include the removable electronic drum head flesh hoop 304 and instead is supported by the deadening pad 106. The drum head 108 includes a drum head flesh hoop 310 to help secure the drum head 108 to the drum 102. The data cable 114 can extend from the trigger sensor 112 on the removable electronic drum head 104 to the electronic device 116 (not shown).

The triggers 302 can be a mesh like structure that covers at least a portion of the removable electronic drum head 104. When the drum head 108 is struck, the impact is detected by the triggers 302 and the triggers 302 send a signal to the trigger sensor 112 to indicate that the drum head 108 was struck. The size adjustment mechanism 306 can be used to adjust the circumference of the removable electronic drum head 104. This allows the removable electronic drum head 104 to be able to fit a wide variety of drums.

Turning to FIG. 4, FIG. 4 illustrates a block diagram view of a portion of the drum 102. As illustrated in FIG. 4, the removable electronic drum head 104 can include the triggers 302. The triggers 302 can be a mesh like structure that covers at least a portion of the removable electronic drum head 104. When the drum head 108 is struck, the impact is detected by the triggers 302 and the triggers 302 send a signal to the trigger sensor 112 (not shown) to indicate that the drum head 108 was struck.

Turning to FIG. 5, FIG. 5 illustrates a block diagram view of a portion of the drum 102. As illustrated in FIG. 5, the drum 102 can include the drum head 108, the removable electronic drum head 104, the deadening pad 106, and the shell 118. The deadening pad 106 can include the deadening pad flesh hoop 308. The deadening pad flesh hoop 308 helps to secure/support the deadening pad 106 to/on the shell 118 of the drum 102. In some examples, other means are used to secure/support the deadening pad to/on the shell of the drum 102. The removable electronic drum head 104 can include the trigger sensor 112, triggers 302 (not shown), and the removable electronic drum head flesh hoop 304. The removable electronic drum head flesh hoop 304 helps to secure/support the removable electronic drum head 104 to/on the shell 118 of the drum 102. In some examples, other means are used to secure/support the removable electronic drum head 104 to/on the shell of the drum 102. In some examples, the removable electronic drum head 104 does not include the removable electronic drum head flesh hoop 304 and instead is supported by the deadening pad 106. The drum head 108 includes the drum head flesh hoop 310 to help secure the drum head 108 to the drum 102. In some examples, other means are used to secure/support the drum head 108 to/on the shell of the drum 102. In some examples, the data cable 114 extends from the trigger sensor 112, over the deadening pad flesh hoop 308, which is over the shell 118 of the drum, and to the electronic device 116.

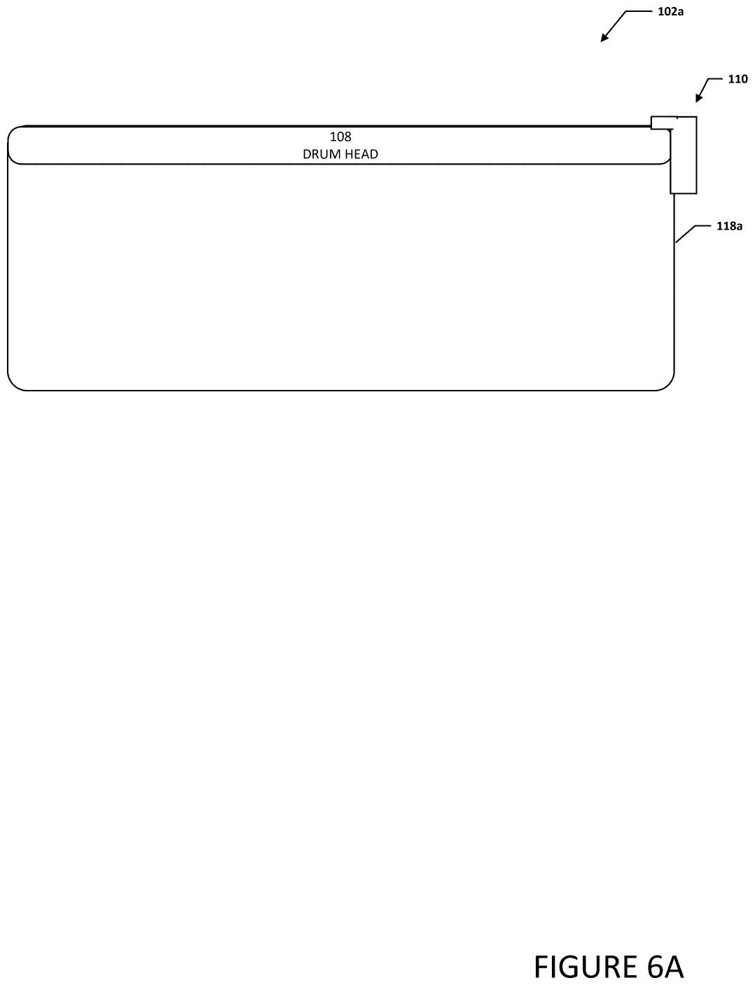

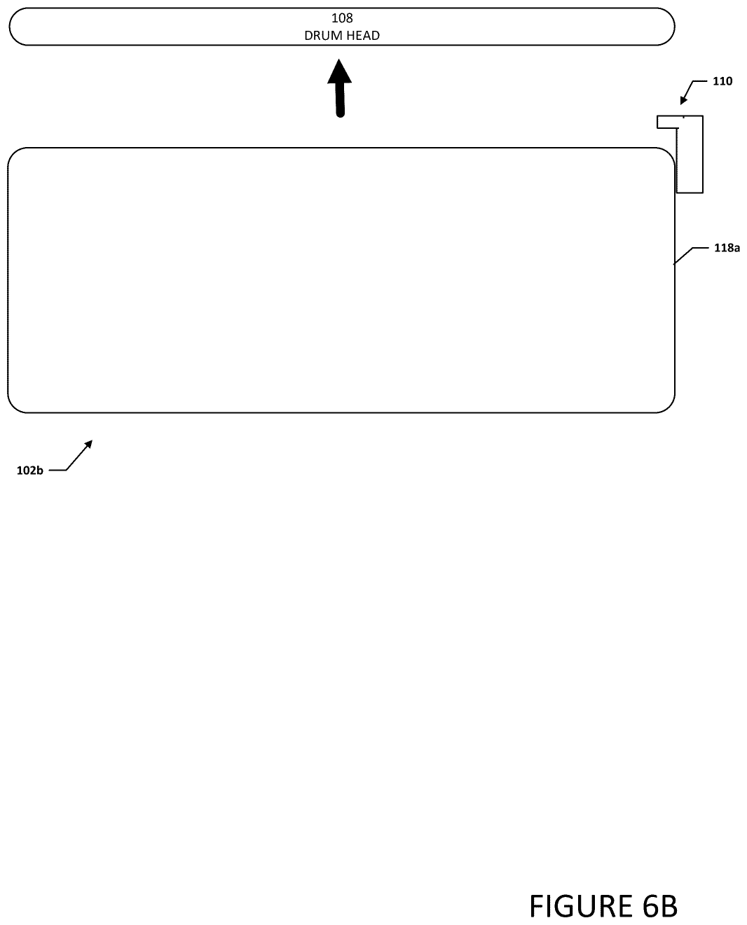

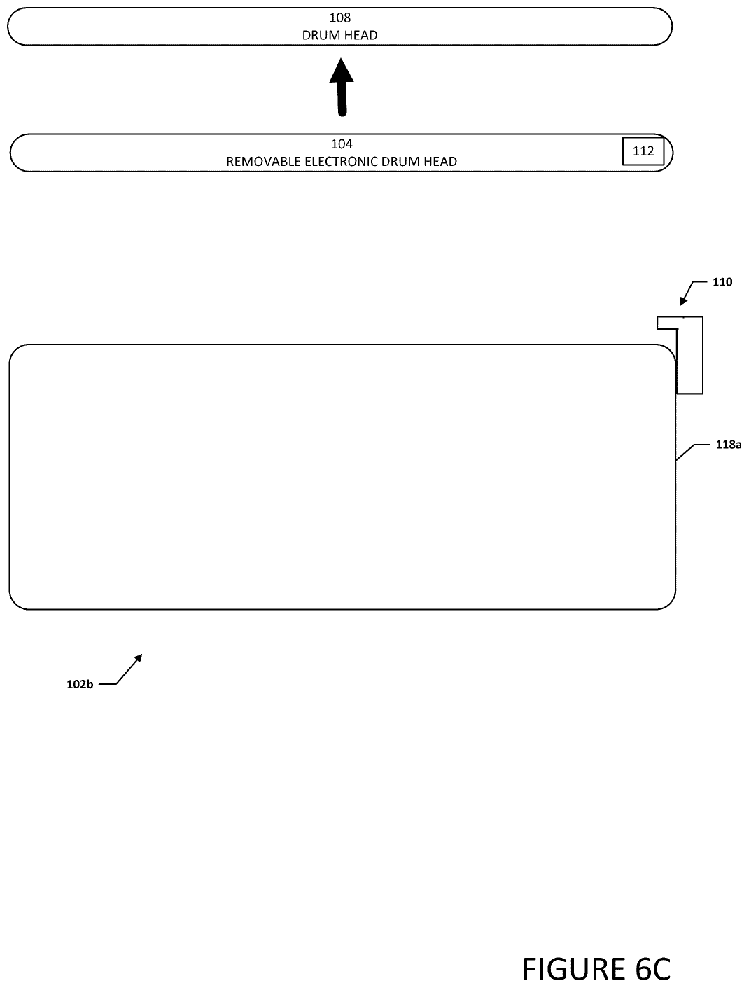

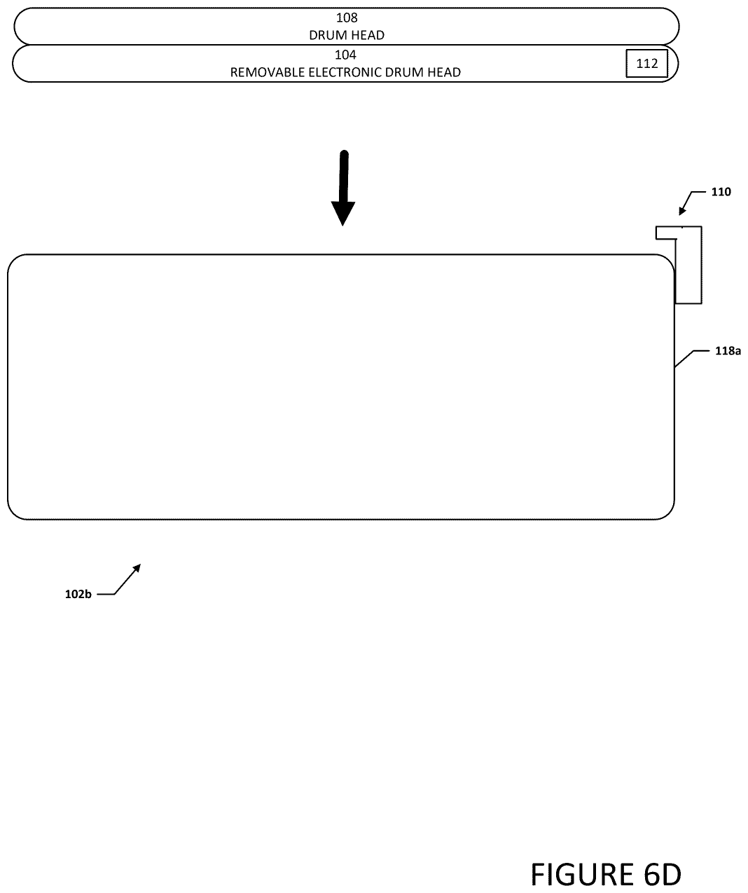

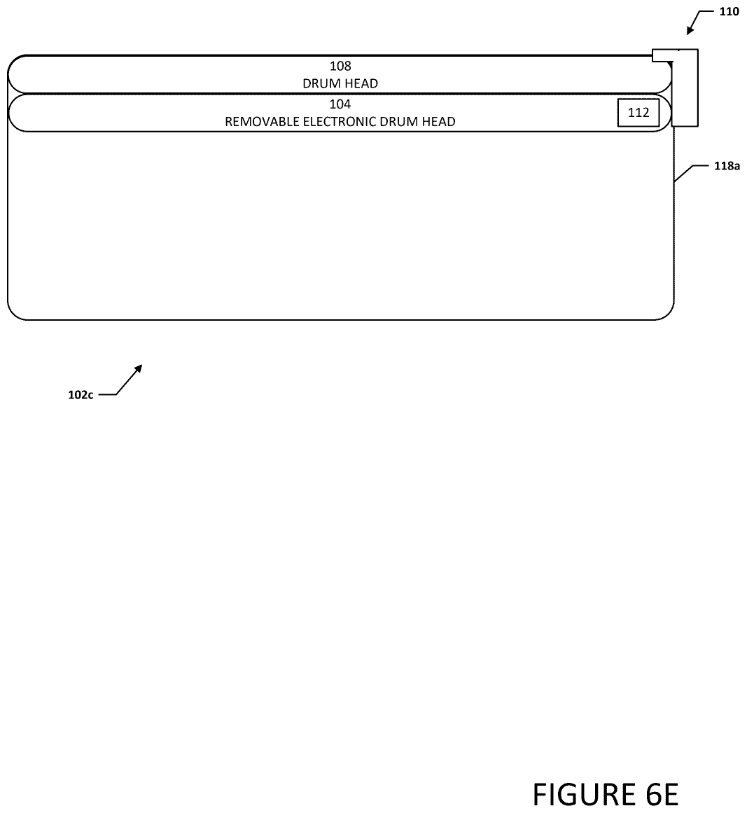

Turning to FIG. 6A, FIG. 6A illustrates a block diagram view of a portion of a drum 102a. The drum 102a can include the drum head 108 and the drum head release mechanism 110. The drum 102a can be almost any acoustic snare drum or some other type of drum where the drum head 108 can be removed. In some examples, depending on the type of drum 102a, the drum head release mechanism 110 represents bolts, called tension rods, that are screwed into lugs on the shell 118a of the drum 102a. In other examples, the drum head release mechanism 110 represents other means that are used to attached or secure the drum head 108 to the shell 118a of the drum 102a.

Turning to FIG. 6B, FIG. 6B illustrates a block diagram view of a portion of a drum 102b. The drum 102b is the same as the drum 102a except the drum head 108 has been removed. As illustrated in FIG. 6B, the drum head release mechanism 110 can be activated and the drum head 108 can be removed.

Turning to FIG. 6C, FIG. 6C illustrates a block diagram view of a portion of the drum 102b. The drum 102b is the same as the drum 102a except the drum head 108 has been removed. As illustrated in FIG. 6C, after the drum head release mechanism 110 is activated and the drum head 108 is removed, the removable electronic drum head 104 can be positioned between the drum 102b and the removed drum head 108.

Turning to FIG. 6D, FIG. 6D illustrates a block diagram view of a portion of the drum 102b. The drum 102b is the same as the drum 102a except the drum head 108 has been removed. As illustrated in FIG. 6D, after the drum head release mechanism 110 is activated and the drum head 108 is removed, the removable electronic drum head 104 can be positioned under the removed drum head 108.

Turning to FIG. 6E, FIG. 6E illustrates a block diagram view of a portion of a drum 102c. The drum 102c is the same as the drum 102a except the removable electronic drum head 104 has been added under the drum head 108. As illustrated in FIG. 6E, after the drum head release mechanism 110 is activated and the drum head 108 is removed, the drum head 108 and the removable electronic drum head 104 can be secured to the drum 102b using the drum head release mechanism 110 to create the drum 102c. Note that is some examples, after the drum head 108 is removed, the removable electronic drum head 104 can be placed in the drum and then the drum head 108 can be placed over the removable electronic drum head 104 to create the drum 102c.

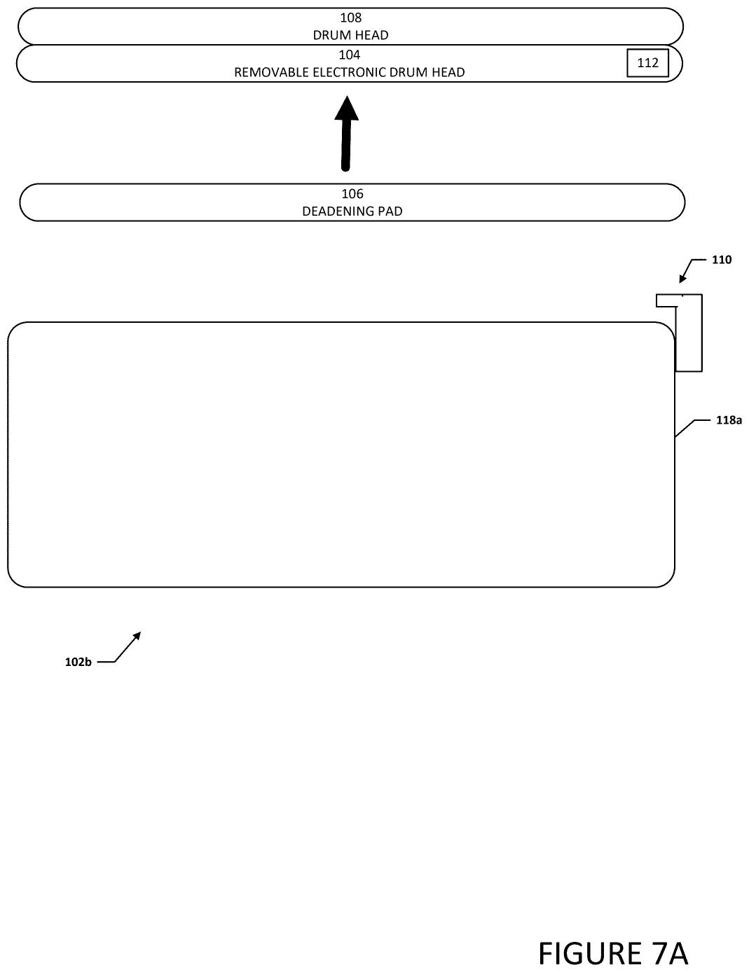

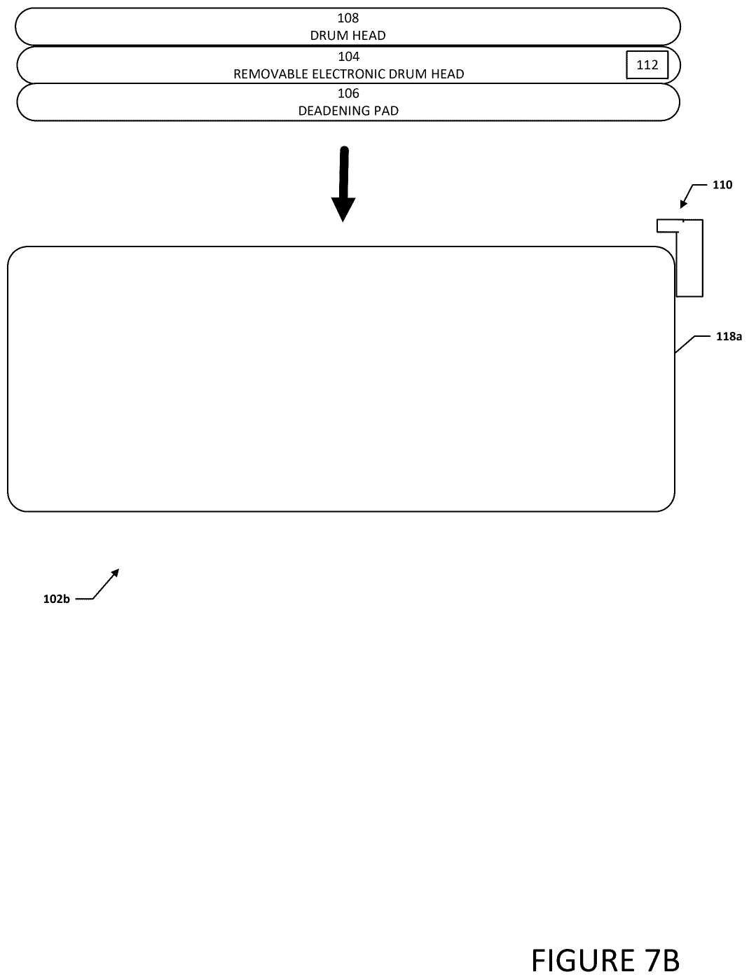

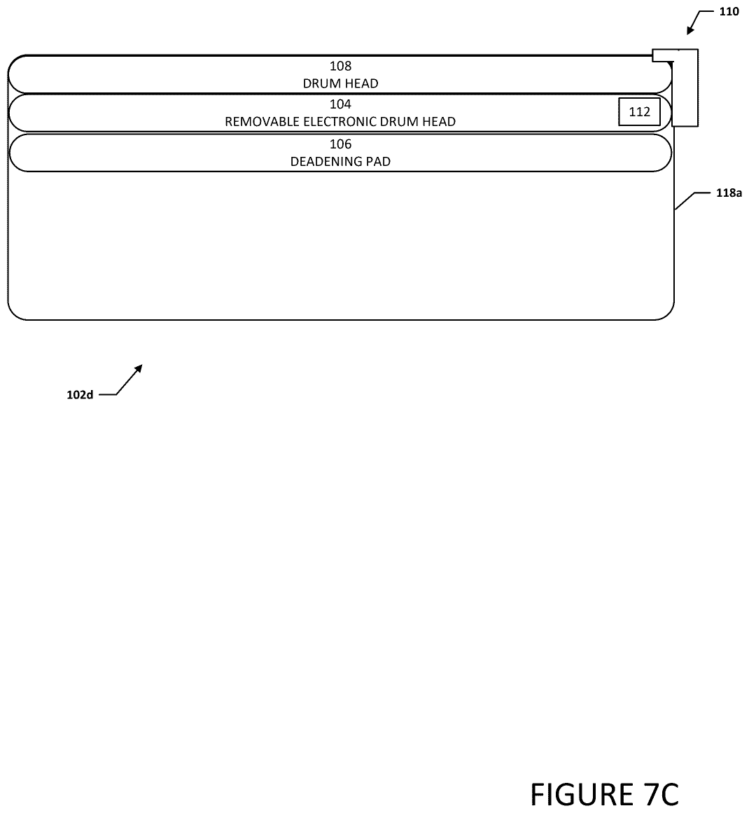

Turning to FIG. 7A, FIG. 7A illustrates a block diagram view of a portion of the drum 102b. The drum 102b is the same as the drum 102a except the drum head 108 has been removed. As illustrated in FIG. 7A, after the drum head 108 is removed and the removable electronic drum head 104 is positioned under the removed drum head 108, the deadening pad 106 can be positioned between the removable electronic drum head 104 and the drum 102b.

Turning to FIG. 7B, FIG. 7B illustrates a block diagram view of a portion of the drum 102b. The drum 102b is the same as the drum 102a except the drum head 108 has been removed. As illustrated in FIG. 7A, after the drum head 108 is removed and the removable electronic drum head 104 is positioned under the removed drum head 108, the deadening pad 106 can be positioned under the removable electronic drum head 104.

Turning to FIG. 7C, FIG. 7C illustrates a block diagram view of a portion of a drum 102d. The drum 102d is the same as the drum 102c except the deadening pad 106 has been added under the drum head 108 and the removable electronic drum head 104. As illustrated in FIG. 7C, the drum head 108, the removable electronic drum head 104, and the deadening pad 106 can be secured using the drum head release mechanism 110 to create the drum 102d. Note that is some examples, after the drum head 108 is removed, the deadening pad 106 can be placed in the drum, the removable electronic drum head 104 can be placed in the drum over the deadening pad 106, and then the drum head 108 can be placed over the removable electronic drum head 104 to create the drum 102d.

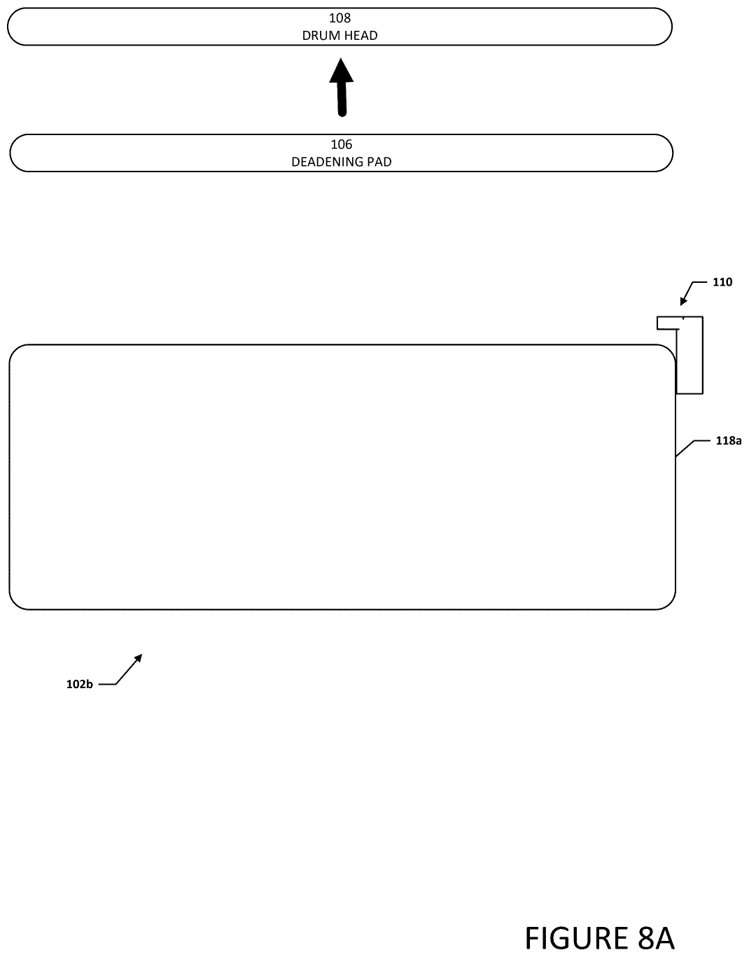

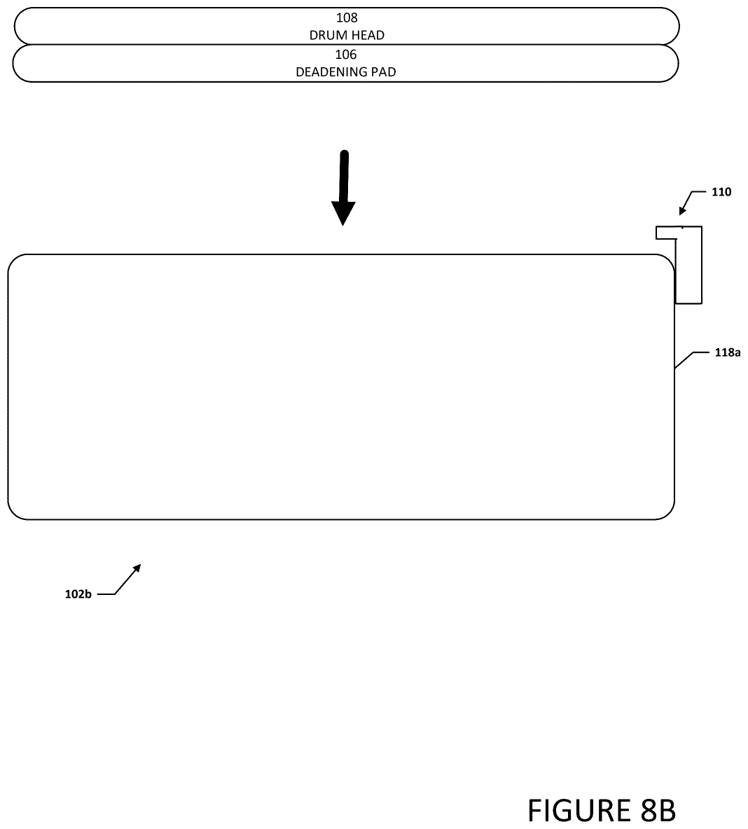

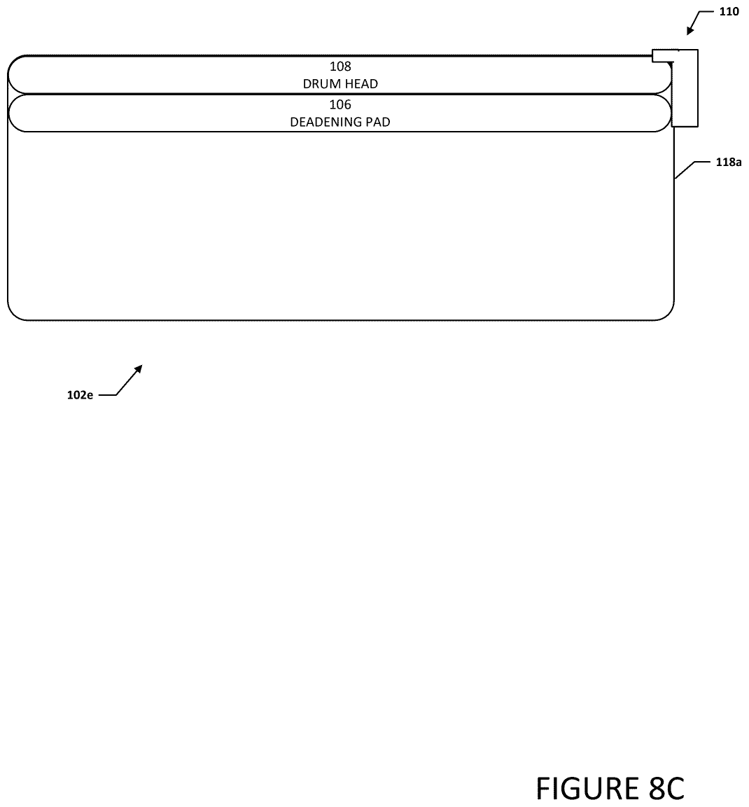

Turning to FIG. 8A, FIG. 8A illustrates a block diagram view of a portion of the drum 102b. The drum 102b is the same as the drum 102a except the drum head 108 has been removed. As illustrated in FIG. 8A, after the drum head release mechanism 110 is activated and the drum head 108 is removed, the deadening pad 106 can be positioned between the drum 102b and the removed drum head 108.

Turning to FIG. 8B, FIG. 8B illustrates a block diagram view of a portion of the drum 102b. The drum 102b is the same as the drum 102a except the drum head 108 has been removed. As illustrated in FIG. 8B, after the drum head release mechanism 110 is activated and the drum head 108 is removed, the deadening pad 106 can be positioned under the removed drum head 108.

Turning to FIG. 8C, FIG. 8C illustrates a block diagram view of a portion of a drum 102e. The drum 102e is the same as the drum 102a except the deadening pad 106 has been added under the drum head 108. As illustrated in FIG. 8C, after the drum head release mechanism 110 is activated and the drum head 108 is removed, the drum head 108 and the deadening pad 106 can be secured using the drum head release mechanism 110 to create the drum 102e. Note that is some examples, after the drum head 108 is removed, the deadening pad 106 can be placed in the drum and then the drum head 108 can be placed over the removable electronic drum head 104 to create the drum 102e.

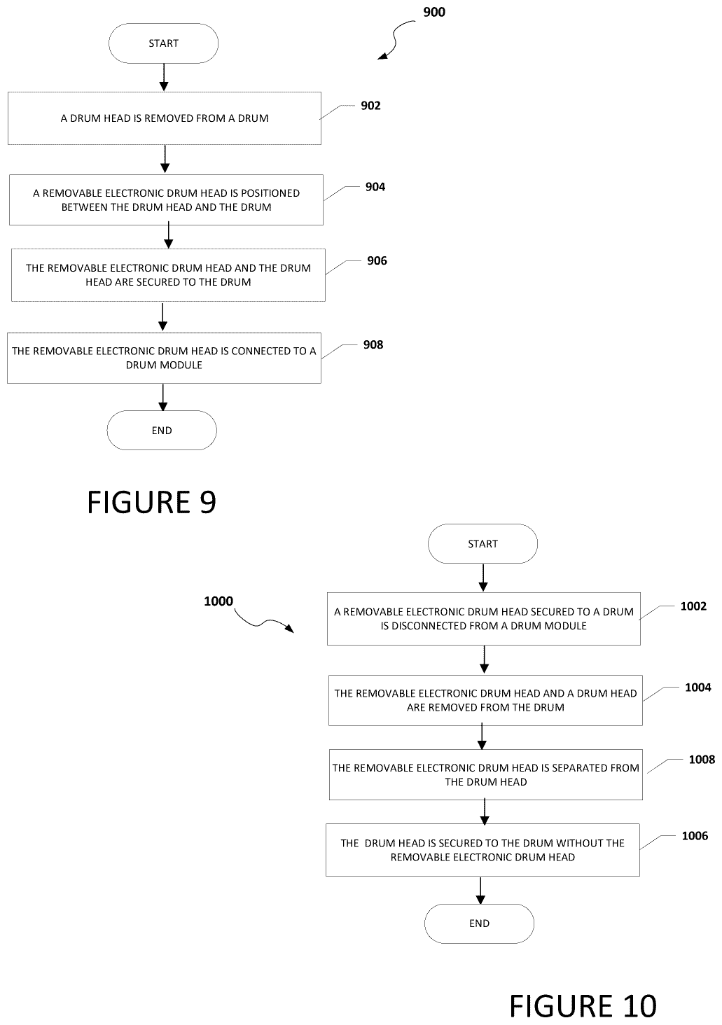

Turning to FIG. 9, FIG. 9 is an example flowchart illustrating possible operations of a flow 900 that may be associated with a removable electronic drum head and/or deadening pad, in accordance with an embodiment. At 902, a drum head is removed from a drum. At 904, a removable electronic drum head is positioned between the drum head and the drum. At 906, the removable electronic drum head and the drum head are secured to the drum. At 908, the removable electronic drum head is connected to a drum module to create an electronic drum.

Turning to FIG. 10, FIG. 10 is an example flowchart illustrating possible operations of a flow 1000 that may be associated with a removable electronic drum head and/or deadening pad, in accordance with an embodiment. At 1002, a removable electronic drum head secured to a drum is disconnected from a drum module. At 1004, the removable electronic drum head and a drum head are removed from the drum. At 1006, the removable electronic drum head is separated from the drum head. At 1008, the drum head is secured to the drum without the removable electronic drum head.

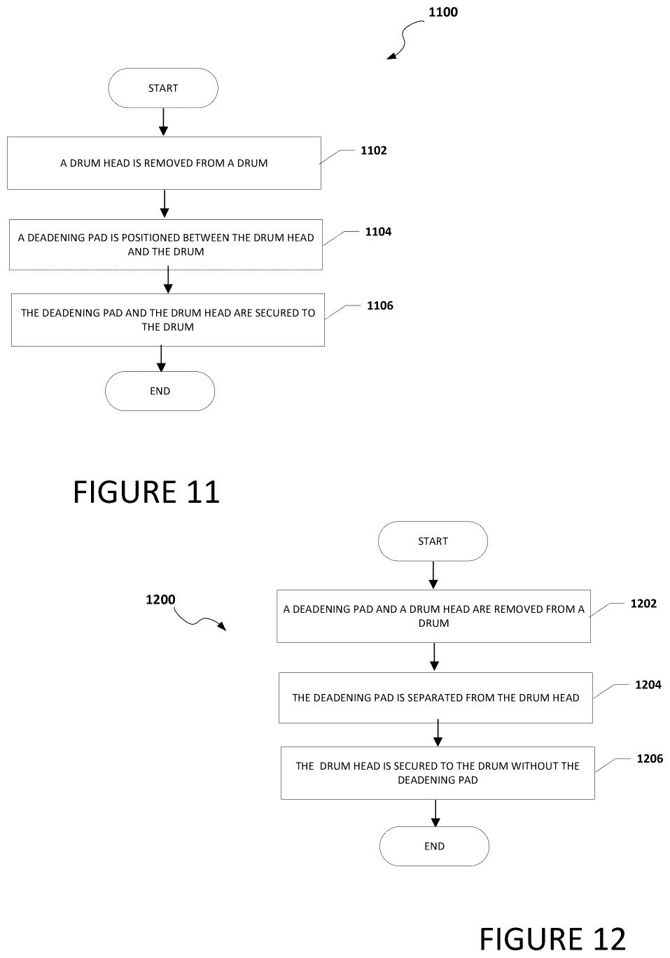

Turning to FIG. 11, FIG. 11 is an example flowchart illustrating possible operations of a flow 1100 that may be associated with a removable electronic drum head and/or deadening pad, in accordance with an embodiment. At 1102, a drum head is removed from a drum. At 1104, a deadening pad is positioned between the drum head and the drum. At 1106, the deadening pad and the drum head are secured to the drum.

Turning to FIG. 12, FIG. 12 is an example flowchart illustrating possible operations of a flow 1200 that may be associated with a removable electronic drum head and/or deadening pad, in accordance with an embodiment. At 1202, a deadening pad and a drum head are removed from a drum. At 1204, the deadening pad is separated from the drum head. At 1206, the drum head is secured to the drum without the deadening pad.

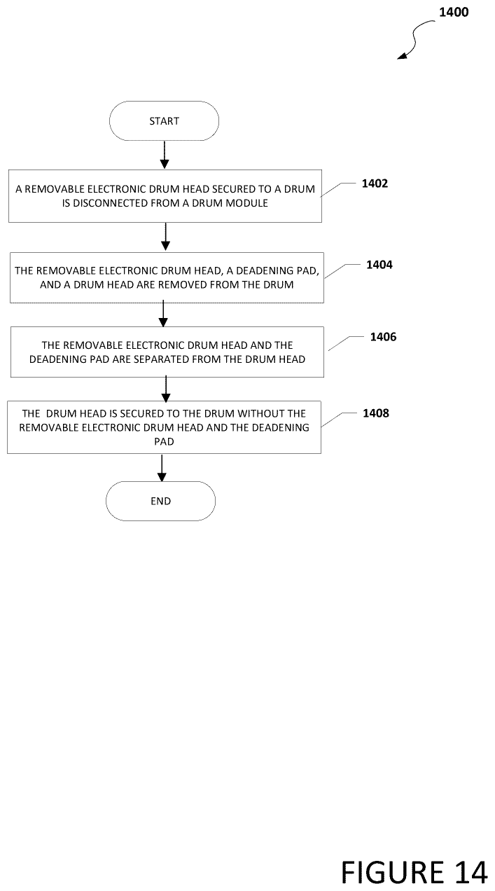

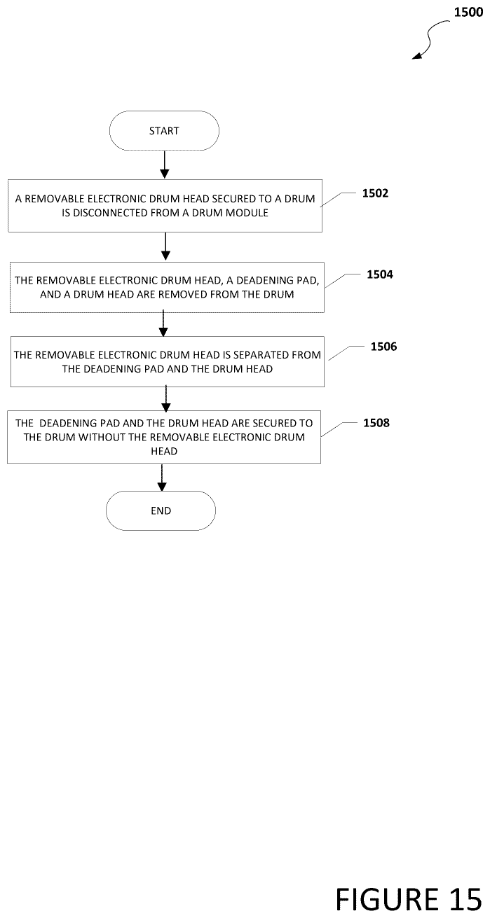

Turning to FIG. 14, FIG. 14 is an example flowchart illustrating possible operations of a flow 1400 that may be associated with a removable electronic drum head and/or deadening pad, in accordance with an embodiment. At 1402, a drum head is removed from a drum. At 1404, a removable electronic drum head is positioned between the drum head and the drum. At 1406, a deadening pad is positioned between the removable electronic drum head and the drum. At 1408, the deadening pad, the removable electronic drum head, and the drum head are secured to the drum. At 1410, the removable electronic drum head is connected to a drum module to create an electronic drum.

Turning to FIG. 15, FIG. 15 is an example flowchart illustrating possible operations of a flow 1500 that may be associated with a removable electronic drum head and/or deadening pad, in accordance with an embodiment. At 1502, a removable electronic drum head secured to a drum is disconnected from a drum module. At 1504, the removable electronic drum head, a deadening pad, and a drum head are removed from the drum. At 1506, the removable electronic drum head is separated from the deadening pad and the drum head. At 1508, the deadening pad and the drum head are secured to the drum without the removable electronic drum head.

Substantial flexibility is provided by the removable electronic drum head and/or deadening pad in that any suitable arrangements, chronologies, configurations, and mechanisms may be provided without departing from the teachings of the present disclosure. Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the removable electronic drum head and/or deadening pad and their teachings are readily scalable and can accommodate a large number of components, as well as more complicated/sophisticated arrangements and configurations. Accordingly, the examples provided should not limit the scope or inhibit the broad teachings of the removable electronic drum head and/or deadening pad as potentially applied to a myriad of other systems.

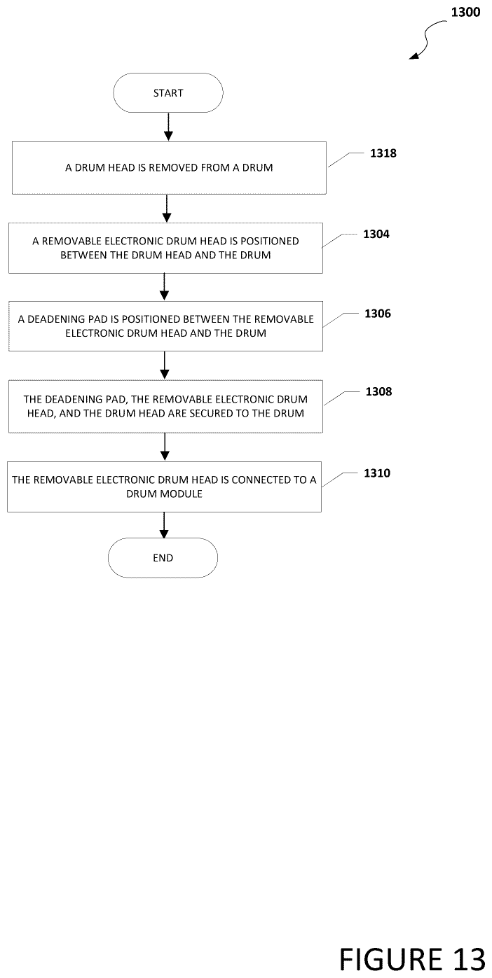

It is also important to note that the operations in the preceding flow diagrams (i.e., FIGS. 9-15) illustrate only some of the possible correlating scenarios and patterns that may be executed. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations of the removable electronic drum head and/or deadening pad, these example configurations and arrangements may be changed significantly without departing from the scope of the present disclosure. Moreover, certain components may be combined, separated, eliminated, or added based on particular needs and implementations. Additionally, although the removable electronic drum head and/or deadening pad have been illustrated with reference to particular elements and operations, these elements and operations may be replaced by any suitable architecture, protocols, and/or processes that achieve the intended functionality of the removable electronic drum head and/or deadening pad.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S. C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A drum comprising:
a drum head;
a removable electronic drum head under the drum head;
a deadening pad under the removable electronic drum head; and
a drum head release mechanism, wherein the drum head release mechanism can be activated to allow the drum head, the removable electronic drum head, and the deadening pad to be removed from the drum and then can be reactivated to secure the drum head to the drum without the removable electronic drum head, and the deadening pad.

2. The drum of claim 1, wherein the removable electronic drum head is in communication with a drum module using a data cable to convert the drum to an electronic drum.

3. The drum of claim 2, wherein the data cable is a ribbon data cable.

4. The drum of claim 2, wherein a thickness of the data cable is less than about three (3) millimeters.

5. The drum of claim 2, wherein a thickness of the data cable is between about 0.2 mm to about 2.5 millimeters.

6. The drum of claim 1, wherein a thickness of the removable electronic drum head is less than about one (1) inch.

7. The drum of claim 1, wherein a thickness of the removable electronic drum head is between about 0.1 inches to about 0.75 inches.

8. The drum of claim 1, wherein the drum is a snare drum.

9. A method comprising:
removing a drum head from an acoustic drum;
positioning a removable electronic drum head under the drum head, wherein the removable electronic drum head includes triggers and one or more trigger sensors;
securing the drum head and the removable electronic drum head to the acoustic drum; and
coupling the removable electronic drum head with a drum module using a data cable to convert the acoustic drum into an electronic drum.

10. The method of claim 9, further comprising:
removing the data cable from the drum module to convert the electronic drum back to an acoustic drum.

11. The method of claim 9, further comprising:
removing the drum head and the removable electronic drum head from the electronic drum;
separating the drum head from the removable electronic drum head; and
attaching the drum head to the acoustic drum without the removable electronic drum head to revert the electronic drum back to the acoustic drum.

12. The method of claim 9, further comprising:
positioning a deadening pad under removable electronic drum head before the drum head and the removable electronic drum head are secured to the acoustic drum; and
securing the drum head, the removable electronic drum head, and the deadening pad to the acoustic drum to convert the acoustic drum into the electronic drum.

13. The method of claim 12, further comprising:
removing the drum head, the removable electronic drum head, and the deadening pad from the electronic drum;
separating the drum head from the removable electronic drum head and the deadening pad; and
attaching the drum head to the acoustic drum without the removable electronic drum head and the deadening pad.

14. The method of claim 12, further comprising:
removing the drum head, the removable electronic drum head, and the deadening pad from the electronic drum;
separating the drum head and the deadening pad from the removable electronic drum head; and
attaching the drum head and the deadening pad to the acoustic drum without the removable electronic drum head.

15. The method of claim 9, wherein a thickness of the data cable is less than about three (3) millimeters.

16. The method of claim 9, wherein a thickness of the data cable is between about 0.2 mm to about 2.5 millimeters.

17. The method of claim 9, wherein a thickness of the removable electronic drum head is less than about one (1) inch.

18. The method of claim 9, wherein a thickness of the removable electronic drum head is between about 0.1 inches to about 0.75 inches.

19. A system for converting an acoustic drum to an electronic drum, the system comprising:
a removable electronic drum head, wherein the removable electronic drum head can be positioned under a drum head of the acoustic drum; and
a deadening pad, wherein the deadening pad can be positioned under the removable electronic drum head, wherein a drum head release mechanism can be activated to help secure the drum head, the removable electronic drum head, and the deadening pad to the acoustic drum to convert the acoustic drum into the electronic drum and can be reactivated to remove the drum head, the removable electronic drum head, and the deadening pad from the electronic drum and then reactivated to secure the drum head without the removable electronic drum head and the deadening pad to the acoustic drum to convert the electronic drum back into the acoustic drum.

20. The system of claim 19, wherein the removable electronic drum head includes triggers, one or more trigger sensor, and a ribbon data cable, wherein the ribbon data cable can be connected to a drum module.
